(19) United States
(12) Patent Application Publication
(10) Pub. No.: US 2026/0144260 A1
(43) Pub. Date: May 28, 2026

(54) COMPOSITION AND METHOD FOR IMPROVING AGRONOMIC TRAITS OF A PLANT

(71) Applicant: The Board of Trustees of the University of Illinois, Urbana, IL (US)

(72) Inventor: Ken N. Paige, Monticello, IL (US)

(21) Appl. No.: 19/401,498

(22) Filed: Nov. 26, 2025

Related U.S. Application Data
(60) Provisional application No. 63/725,118, filed on Nov. 26, 2024.

(51) Int. Cl. A01N 43/84; A01N 25/30; A01N 43/54; A01N 43/653; A01P 13/00; A01P 21/00

(52) U.S. Cl. CPC A01N 43/84; A01N 25/30; A01N 43/54; A01N 43/653; A01P 13/00; A01P 21/00

(57) ABSTRACT

Compositions and methods for improving one or more agronomic traits of a plant are provided, which include the use of one or more active ingredients that are herbicides that kill, damage, or inhibit the growth of cells in the shoot apical meristem and optionally one or more surfactants, fungicides, bactericides, and/or pesticides. Use of the composition at specific vegetative growth stages of the plant, for example, between vegetative growth stage 1 (V1) and vegetative growth stage 6 (V6) is described.

### INTRODUCTION

This application claims the benefit of priority of U.S. Provisional Application No. 63/725,118, filed Nov. 26, 2024, the content of which is incorporated herein by reference in its entirety.

### BACKGROUND OF THE INVENTION

There is a need for reproducible, cost-effective, and sustainable methods for improving plant agronomic traits. Climate change is reducing the amount of arable land around the world. At the same time, the world population is increasing. Petrochemical-based agriculture, which uses large amounts of fuel and organic pesticides to meet food demands, is not sustainable because of climate change. Plant-based fuels must replace petrochemical fuels to reduce global warming, but cultivation of oil seed crops compete with much needed food production. Consequently, there is a growing demand for methods and new plant cultivars capable of improving agronomic traits such as yield, drought tolerance, disease resistance, and the like.

Plants possess a myriad of defense mechanisms against herbivores, pathogens, and pests. One such defense mechanism is the constitutive or inducible production of chemical compounds to deter infestation. This defense strategy is called resistance or chemical resistance. Another defense mechanism involves regrowth strategies known as tolerance. One possible outcome is the phenomenon known as overcompensation wherein one or more agronomic traits, including seed production, are improved. If the apical meristem of the plant is removed, or the growth of the apical meristem is inhibited, plants may undergo endoreplication thereby increasing their fitness via the phenomenon of overcompensation. Endoreduplication is the replication of the genome without mitosis. For example, it has been demonstrated that the Arabidopsis thaliana ecotype Columbia-4 employs endoreduplication following removal of the shoot apical meristem and that it overcompensates, i.e., increases seed yield (Scholes & Paige (2014) Molecular Ecology 23:4862-4870). U.S. Pat. No. 11,751,522 B2 describes a method of improving agronomic traits of plants, including yield, drought tolerance, and pest/pathogen resistance by clipping the plant's shoot apical meristem at an advantageous time in the growth cycle of the plant. For example, this patent discloses that removal of the shoot application meristem of soybean plants between vegetative stage 1 and 2 or vegetative stage 2 and 3 improves several agronomic traits including seed yield and vigor.

There is a need to improve plant agronomic traits. The present invention addresses this need in the art.

### SUMMARY OF THE INVENTION

The present invention provides a method of improving one or more agronomic traits of a plant by applying a composition comprising one or more herbicides to the shoot apical meristem of the plant in an amount effective to kill, damage, or inhibit the growth of cells in the shoot apical meri stem.

In one embodiment, described herein is a method of improving one or more agronomic traits of a plant comprising applying a composition comprising one or more herbicides or active ingredients that are herbicides to the shoot apical meristem of the plant in an amount effective to kill, damage, or inhibit the growth of cells in the shoot apical meristem and improving one or more agronomic traits of the plant compared to an untreated control plant.

One or more active ingredients that are herbicides may be part of the composition. The active ingredients that are herbicides are selected from the group consisting of a lipid synthesis inhibitor, an amino acid synthesis inhibitor, a growth regulator, a photosynthesis inhibitor, a nitrogen metabolism inhibitor, a pigment inhibitor, a cell membrane disruptor, a seedling root growth inhibitor, a seedling shoot growth inhibitor, and combinations thereof.

In an embodiment, the one or more active ingredients that are herbicides is selected from the group consisting of an acetyl CoA carboxylase inhibitor, acetolactate synthase inhibitor, 5-enolpyruvyl-shikimate-3-phosphate synthase inhibitor, auxin transport inhibitor, photosystem II inhibitor, glutamine synthase inhibitor, diterpene synthesis inhibitor, 4-hydroxyphenyl-pyruvate dioxygenase inhibitor, proto-porphyrinogen oxidase inhibitor, photosystem I electron diverter, microtubule inhibitor, non-acetyl CoA carboxylase lipid synthesis inhibitor, a long-chain fatty acid synthesis inhibitor and combinations thereof.

The one or more active ingredients that are herbicides can also be selected from the group consisting of fenoxaprop, fluazfop, quizalofop, clethodim, sethoxydim, chlorimuron, foramsulfuron, halosulfuron, iodosulfuron, nicosulfuron, primisulfuron, prosulfuron, timsulfuron, thifensulfuron, tribenuro, imazamox, imazaquin, imazapyr, imazethapyr, flumetsulam, cloransulam, thiencarbazone, thiencarbazone, glyphosate, 2,4-D, dicamba, clopyalid, fluroxypyr, difufenzopyr, atrazine, simazine, metribuzin, bromoxynil, bentazon, linuron, glufosinate, clomazone, isoxaflutole, topramezone, mesotrione, tembotrione, acifluorfen, fomesafen, lactofen, flumiclorac, sulfentrazone, carfentrazone, fluthiacet-ethyl, saflufenacil, paraquat, ethalfluralin, pendimethalin, trifluralin, butylate, EPTC, acetochlor, alachlor, metolachlor, dimethenamid, flufenacet, pyroxasulfone, and combinations thereof.

In an embodiment of the method, the one or more active ingredients that are herbicides does not comprise lactofen and the composition further comprises one or more surfactants. Exemplary surfactants include polyoxyethylene sorbitan esters, polyoxyethylene alcohols, alkylarylpolyether alcohols, phthalic glycerol alkyl resins, ethoxylated imidazoline, decanoic acid, diglycol oleate, polyether sulfonates, alkylaryl sulfonates, and combinations thereof.

A composition comprising one or more active ingredients that are herbicides and optionally a surfactant, bactericide or fungicide is applied to the shoot apical meristem of the plant at a rate from about 0.1 ounces/acre to about 20 ounces/acre. In one embodiment, the composition is applied to the shoot apical meristem of the plant at a rate of about 0.1 ounces/acre, 0.2 ounces/acre, 0.3 ounces/acre, 0.4 ounces/acre, 0.5 ounces/acre, 0.6 ounces/acre, 0.7 ounces/acre, 0.8 ounces/acre, 0.9 ounces/acre, 1.0 ounces/acre, 1.5 ounces/acre, 2.0 ounces/acre, 2.5 ounces/acre, 3.0 ounces/acre, 3.5 ounces/acre, 4.0 ounces/acre, 4.5 ounces/acre, 5.0 ounces/acre, 5.5 ounces/acre, 6.0 ounces/acre, 7.0 ounces/acre, 8.0 ounces/acre, 9.0 ounces/acre, 10.0 ounces/acre, or any value derivable therein.

In one embodiment, the concentration of the active ingredients that are herbicides in the composition is expressed in molarity (molar or M), or as millimolar (mM) and is in a range from about 0.01 mM to about 5.0 mM.

In one embodiment, the one or more surfactants is selected from the group consisting of polyoxyethylene (20) sorbitan monolaurate, polyoxyethylene (4) sorbitan monolaurate, polyoxyethylene (2) sorbitan monopalmitate, polyoxyethylene (20) sorbitan monostearate, polyoxyethylene (20) sorbitan monooleate, ethoxylated imidazoline, polyoxyethylene fatty glyceride, polyoxyethylene fatty glyceride, polyoxyethylene (12) dodecylophenol and combinations thereof. The total weight of the one or more surfactants in the composition is approximately equal to the total weight of the one or more herbicides in the composition. Compositions disclosed here can further comprises one or more fungicides, bactericides, and/or pesticides.

In one embodiment, the one or more agronomic traits improved according to the inventive method is seed yield, tuber yield, fruit yield, pod yield, seed oil content, seed protein content, seed starch content, biomass, flower number, drought tolerance, pest tolerance, pathogen tolerance and combinations thereof. The methods described here further comprise harvesting one or more commercially relevant portions of the plant, for example, seeds, tubers, fruit, pods, oil, protein, starch, leaves, fiber, terpenes, wood, and combinations thereof.

The methods described in this application are used to improve one or more agronomic traits of commercially important plants selected from the group consisting of soybean, corn, canola, rice, cotton, potato, sunflower, camelina, and rape.

Also described is a method of improving one or more agronomic traits of a plant comprising applying a composition comprising one or more Proto-Porphyrinogen Oxidase (PPO) inhibitors to the shoot apical meristem of the plant in an amount effective to kill, damage, or inhibit the growth of cells in the shoot apical meristem and improving one or more agronomic traits of the plant compared to an untreated control plant.

The PPO inhibitors used here are selected from the group consisting of flumioxazin, saflufenacil, and sulfentrazone.

In an embodiment, the composition comprising the PPO inhibitors can further comprise one or more surfactants. Exemplary surfactants include polyoxyethylene sorbitan esters, polyoxyethylene alcohols, alkylarylpolyether alcohols, phthalic glycerol alkyl resins, ethoxylated imidazoline, decanoic acid, diglycol oleate, polyether sulfonates, alkylaryl sulfonates, and combinations thereof.

In one embodiment, the one or more surfactants is selected from the group consisting of polyoxyethylene (20) sorbitan monolaurate, polyoxyethylene (4) sorbitan monolaurate, polyoxyethylene (2) sorbitan monopalmitate, polyoxyethylene (20) sorbitan monostearate, polyoxyethylene (20) sorbitan monooleate, ethoxylated imidazoline, polyoxyethylene fatty glyceride, polyoxyethylene fatty glyceride, polyoxyethylene (12) dodecylophenol and combinations thereof. Furthermore, in some embodiments, the ratio of herbicide to surfactant is in a range from 0.1:1.5 or 1.5-0.1.

In one embodiment, the concentration of the PPO inhibitors in the composition is expressed in molarity (molar or M), or as millimolar (mM) and is in a range from about 0.01 mM to about 5.0 mM.

### DESCRIPTION OF THE FIGURE

FIG. 1 is a bar graph showing the increase in yield of soybeans expressed as bushels/acre for two herbicide compositions, namely VALOR® and VERDICT®.

### DETAILED DESCRIPTION OF THE INVENTION

The following descriptions and examples illustrate embodiments of the present disclosure in detail. Although the present disclosure has been described in some details by way of illustration and example for purposes of clarity and understanding, it will be apparent that certain changes and modifications can be practiced within the scope of the appended claims.

Although various features of the disclosure can be described in the context of a single embodiment, the features can also be provided separately or in any suitable combination. Conversely, although the present disclosure can be described herein in the context of separate embodiments for clarity, the present disclosure can also be implemented in a single embodiment. It is to be understood that the present disclosure is not limited to particular aspects described herein and as such can vary. Those of skill in the art will recognize that there can be variations and modifications of the present disclosure, which are encompassed within its scope.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All terms are intended to be understood as they would be understood by a person skilled in the art. Unless defined otherwise, all technical and scientific terms used herein have the same meaning as commonly understood by one of ordinary skill in the art to which the disclosure pertains.

In this application, the use of the singular includes the plural unless specifically stated otherwise. It must be noted that, as used in the specification, the singular forms “a,” “an,” and “the” include plural referents unless the context clearly dictates otherwise.

In this application, the use of “or” means “and/or” unless stated otherwise. The terms “and/of” and “any combination thereof” and their grammatical equivalents as used herein, can be used interchangeably. These terms can convey that any combination is specifically contemplated. Solely for illustrative purposes, the following phrases “A, B, and/or C” or “A, B, C, or any combination thereof” can mean A individually; B individually; C individually; A and B; B and C; A and C; and A, B, and C. The term “or” can be used conjunctively or disjunctively unless the context specifically refers to a disjunctive use.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. It is contemplated that any aspect described herein can be implemented with respect to any method or composition herein, and vice versa. Furthermore, compositions of the present disclosure can be used to achieve the methods described herein.

The term “about” or “approximately” means within an acceptable error range for a particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, up to 10%, up to 5%, or up to 1% of a given value. In another example, the amount “about 10” includes 10 and any amounts from 9 to 11. In yet another example, the term “about” in relation to a reference numerical value can also include a range of values plus or minus 10%, 9%, 8%, 7%, 6%, 5%, 4%, 3%, 2%, or 1% from that value. Alternatively, particularly with respect to biological systems or processes, the term “about” can mean within an order of magnitude, preferably within 5-fold, and more preferably within 2-fold, of a value. Where specific are described in the application and claims, unless otherwise stated the term “about” means within an acceptable error range for the particular value. The term “under suitable condition” or “under suitable reaction condition” refers to any environment that permits a desired reaction to take place.

The term “isolated” refers to a state where a specific material or compound is partially, substantially, or completely free of other materials with which it is associated in nature. By partially or substantially free is meant at least 0.1%, at least 0.5%, at least 1%, at least 5%, at least 10%, at least 20%, at least 30%, at least 40%, at least 50%, at least 60%, at least 70%, at least 80%, at least 90%, at least 99%, or 100% free of the materials with which a specific compound or material is associated with in nature, inclusive of all values falling in between these percentages. Accordingly, as used herein, an “isolated herbicide” refers to an herbicide that has been partially, substantially, or completely separated from its biological source (e.g., microbial organism, yeast, bacteria, etc.). The isolated herbicide may or may not be combined in a formulation with other ingredients for applications disclosed herein. An isolated herbicide may or may not be purified (e.g., free from other environmental contaminants, microbial products, or deactivated organisms, etc.), but it is separated from the source organisms.

The present invention is based, in part, on the discovery that one or more active ingredients that are herbicides, when sprayed on or applied to a plant, at an appropriate time in the plant growth cycle and/or at an appropriate concentration, selectively kills, damages, or inhibits the growth of cells in the shoot apical meristem which results in overcompensation and an improvement in one or more agronomical traits of the treated plant as compared to an untreated control plant. As used herein, “overcompensation” occurs when the shoot apical meristem of the plant is removed, damaged, or the growth of the shoot apical meristem is inhibited. As a result, endoreduplication occurs which results in the replication of the plant genome without mitosis leading to cellular polyploidy, rapid regrowth, and an increase in plant fitness. Overcompensation results in the improvement of one or more agronomic traits of a plant, including, but not limited to, increased biomass, vigor, seed production, fruit production, drought tolerance, seed protein content, seed oil content, and disease resistance, compared to a genetically similar or identical plant that has not had its shoot apical meristem removed, damaged, or the growth of its apical meristem inhibited. Accordingly, in one aspect is provided a method for improving one or more agronomic traits of a plant by applying a composition including one or more active ingredients that are herbicides to the shoot apical meristem in an amount effective to kill, damage, or inhibit the growth of cells in the shoot apical meristem of the plant thereby improving one or more agronomic traits of the plant. In some aspects, the one or more active ingredients that are herbicides may be applied at a concentration sufficient to cause plant stress leading to induction of overcompensation to increase the likelihood of plant survival and reproduction. The methods described herein may be used to improve agronomic traits including, but not limited to, seed yield, tuber yield, drought tolerance, pest/pathogen resistance, disease resistance, salt tolerance, fruit yield, seed pod yield, biomass yield, seed protein yield, seed oil yield, seed starch yield, fiber yield, wood yield, terpene yield, inulin yield, and/or alkaloid yield. As used herein, the term “yield” generally refers to a measurable portion or product of commercial value that is produced by the plant such as fruits or vegetables, nuts, seeds (grains), wood (e.g., in the case of silviculture plants) or even flowers (e.g., in the case of gardening plants, ornamentals). The plant products may in addition be further used and/or processed after harvesting. In some aspects, “increased yield” of a plant, specifically an agricultural, silvicultural and/or ornamental plant, means that the yield of a product of the respective plant is increased by a measurable amount over the yield of the same product of the plant produced under the same conditions, but without removing the shoot apical meristem of the plant. Increased yield may be characterized, among others, by increased plant weight, increased plant height, increase in above-ground and/or below-ground biomass such as higher fresh and/or dry weight, higher grain yield, more tillers, larger leaves, increased shoot growth, increased seed number, increased seed weight, increased seed protein content, increased seed oil content, increased starch content and/or increased pigment content. In some aspects, a plant exposed or contacted with the composition of the invention will exhibit an improvement in seed yield, tuber yield, drought tolerance, pest/pathogen resistance, disease resistance, salt tolerance, fruit yield, seed pod yield, biomass yield, seed protein yield, seed oil content/yield, seed starch content/yield, fiber yield, wood yield, terpene yield, inulin yield, and/or alkaloid yield as compared to a control plant not contacted with the composition.

In certain aspects, improved or increased “yield” refers to one or more yield parameters selected from the group of biomass yield, dry biomass yield, aerial dry biomass yield, underground dry biomass yield, fresh-weight biomass yield, aerial fresh-weight biomass yield, underground fresh-weight biomass yield, and/or preferably enhanced yield of seeds (either dry or fresh-weight, or both). In one aspect, an increase in yield refers to increased harvestable yield, biomass yield and/or an increased seed yield. Biomass yield may be calculated on a per plant basis or in relation to a specific area (e.g., biomass yield per acre/square meter/or the like).

The “harvestable yield” of a plant can depend on the specific plant/crop of interest as well as its intended application (such as food production, feed production, processed food production, biofuel, biogas or alcohol production, or the like) of interest in each case. Thus, in one aspect, yield is calculated as harvest index (expressed as a ratio of the weight of the respective harvestable parts divided by the total biomass), harvestable parts weight per area (acre, square meter, or the like); and the like.

“Biomass yield” can refer to, e.g., dry weight biomass yield and/or fresh-weight biomass yield. Biomass yield refers to the aerial or underground parts of a plant, depending on the specific circumstances (test conditions, specific crop of interest, application of interest, and the like). In one embodiment, biomass yield refers to the aerial and underground parts. Biomass yield may be calculated as fresh-weight, dry weight or a moisture adjusted basis.

“Seed yield” may be measured by one or more of the following parameters: number of seeds or number of filled seeds (per plant or per area (acre/square meter/or the like)); seed filling rate (ratio between number of filled seeds and total number of seeds); number of flowers per plant; seed biomass or total seed weight (per plant or per area (acre/square meter/or the like); thousand kernel weight (TKW; extrapolated from the number of filled seeds counted and their total weight; an increase in TKW may be caused by an increased seed size, an increased seed weight, an increased embryo size, and/or an increased endosperm). Seed yield may be determined on a dry weight or on a fresh weight basis, or typically on a moisture adjusted basis, e.g., at 15.5 percent moisture.

In some aspects, an increase in yield is conferred by an increase of the intrinsic yield capacity of a plant and can be, for example, manifested by improving the specific (intrinsic) seed yield (e.g., in terms of increased seed/grain size, increased ear number, increased seed number per ear, improvement of seed filling, improvement of seed composition, embryo and/or endosperm improvements, or the like); modification and improvement of inherent growth and development mechanisms of a plant (such as plant height, plant growth rate, pod number, pod position on the plant, number of internodes, incidence of pod shatter, efficiency of nodulation and nitrogen fixation, efficiency of carbon assimilation, improvement of seedling vigor/early vigor, enhanced efficiency of germination (under stressed or non-stressed conditions), improvement in plant architecture, cell cycle modifications, photosynthesis modifications, various signaling pathway modifications, modification of transcriptional regulation, modification of translational regulation, modification of enzyme activities, and the like); and/or the like.

In one aspect, an increase in yield is conferred by an improvement or increase of stress tolerance of a plant and can be for example manifested by improving or increasing a plant's tolerance against stress, particularly abiotic stress. In the present application, abiotic stress refers generally to abiotic environmental conditions a plant is typically confronted with, including conditions not limited to, drought (tolerance to drought may be achieved as a result of improved water use efficiency), heat, low temperatures, and cold conditions (such as freezing and chilling conditions), salinity, osmotic stress, shade, high plant density, oxidative stress, and the like. In some aspects, a plant exposed or contacted with the composition of the invention will exhibit an improvement in drought tolerance, pest tolerance, and/or pathogen tolerance.

In another aspect, an improvement in agronomic traits refers to an increase in the nutrient use efficiency of a plant, e.g., by improving the use efficiency of nutrients including, but not limited to, phosphorus, potassium, and nitrogen. For example, there is a need for plants that can use nitrogen more efficiently so that less nitrogen is required for growth, therefore resulting in an improved level of yield under nitrogen deficiency conditions. Further, higher yields may be obtained with current or standard levels of nitrogen use.

Another indicator for the condition of the plant is the “plant vigor.” Plant vigor manifests in several aspects, including the general visual appearance of a plant. Improved plant vigor can be characterized, among others, by improved vitality of the plant, improved plant growth, improved plant development, improved visual appearance, improved plant stand (less plant verse/lodging), improved emergence, enhanced root growth and/or more developed root system, enhanced nodulation, in particular rhizobial nodulation, bigger leaf blade, increased plant size, increased plant weight, increased plant height, increased tiller number, increased shoot growth, increased root growth (extensive root system), increased size of root mass (extensive root system), increased yield when grown on poor soils or unfavorable climate, enhanced photosynthetic activity, change of color (e.g., enhanced pigment content), earlier flowering, earlier fruiting, earlier and improved germination, earlier (advanced) grain maturity, improved abiotic and/or biotic stress tolerance, less non-productive tillers, less dead basal leaves, less input needed (such as fertilizers or water), greener leaves and increased green leaf area, complete maturation under shortened vegetation periods, less fertilizers needed, less seeds needed, easier harvesting, faster and more uniform ripening, longer shelf-life, longer panicles, delay of senescence, stronger and/or more productive tillers, better extractability of ingredients, improved quality of seeds (for being seeded in the following seasons for seed production), reduced production of ethylene and/or the inhibition of its reception by the plant, spindliness of leaves, and/or increased number of ears/m².

The improvement or increase in one or more agronomic traits and/or vigor as described herein means that the improvement of any one or several or all, of the above-mentioned agronomic traits are improved compared to a plant produced under the same conditions, but without damaging, inhibiting, or removing the shoot apical meristem of the plant (i.e., a plant that has not been contacted with a composition of the invention).

In one aspect, vigor and/or yield (e.g., seed yield, tuber yield, fruit yield, etc.) is increased by at least 5% to 100% (e.g., 5%, 10%, 15%, 20%, 25%, 30%, 35%, 40%, 45%, 50%, 55%, 60%, 65%, 70%, 75%, 80%, 85%, 90%, 95%, or 100%, or any value or range derivable therein) compared to untreated control plants. In one aspect, vigor and/or yield (e.g., seed yield, tuber yield, fruit yield, etc.) is increased by least 10% compared to untreated controls. According to another aspect, the vigor and/or yield (e.g., seed yield, tuber yield, fruit yield, etc.) is increased by least 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95%, 100%, or more than 100%, compared to untreated control plants. Byway of example, if untreated soybeans yielded 6200 bushels of seeds per 100 acres, and if soybeans that received the subject treatment yielded 8500 bushels of seeds per 100 acres under the same growing conditions, then the yield of soybeans would be said to have increased by ((8500−6200)/6200)×100=37%. In some aspects, per hectare yield may be increased by 1%, 5%, 10%, 15%, 20%, 25%, 30%, 35%, 40%, 45%, 50%, 60%, 70%, or more through the removal, damage, or inhibition of growth, of the shoot apical meristem.

In some aspects, the improvement in the one or more agronomic traits (e.g., yield and/or vigor) in a plant contacted with the composition described herein is comparable or better than the improvement in one or more agronomic traits of a plant subjected to clipping to remove the apical meristem. The term “clipping” means removal or inhibition of the growth of the shoot apical meristem of a plant by any means of mechanical trimming. Mechanical trimming is accomplished by mowing, pruning by hand, or any other method of severing the apical meristem as a whole, or in part, from the plant.

The term “plant” is to be understood as a plant of economic importance and/or cultivated plant. A plant is preferably selected from an agricultural, silvicultural, and horticultural (including ornamental) plant. The term “plant” as used herein includes all parts of a plant such as germinating seeds, emerging seedlings, herbaceous vegetation as well as established woody plants including all belowground portions (such as the roots) and aboveground portions. Generally, the term “plant” also includes a plant that has been modified by breeding, mutagenesis, or genetic engineering. Genetically modified plants are plants, in which the genetic material is modified using recombinant DNA techniques. The use of recombinant DNA techniques makes modifications possible that cannot readily be obtained by cross breeding under natural circumstances, by mutations, or natural recombination.

In some aspects, a plant of the invention includes, but is not limited to, cereals, for example wheat, rye, barley, triticale, oats or rice; beet, for example sugar beet or fodder beet; fruits, such as pomes, stone fruits or soft fruits, for example apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as broccoli, spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf, natural rubber plants or ornamental and forestry plants, such as flowers, shrubs, broad-leaved trees or evergreens, for example conifers; and on the plant propagation material, such as seeds, and the crop material of these plants. In some aspects, the plant is a leguminous plant, such as lentil, pea, peanut, chickpea, kidney bean, lupine, alfalfa, or soybean. In other aspects, the plant is soybean, corn, canola, rice, cotton, potato, sunflower, camelina, or rape.

The term “meristem” means a region of cells capable of division and growth in plants. Meristematic cells are typically small and nearly spherical. They have a dense cytoplasm and relatively few small vacuoles. Some of these meristematic cells maintain the meristem as a continuing source of new cells and may undergo cell division (mitosis) many times before differentiating into specific cells required for a region of the plant body.

As is conventional in the art, the “shoot apical meristem” is the region in the growing shoot containing meristematic cells. The shoot apical meristem contains pluripotent stem cells and produces primordia that develop into all the above ground organs of a plant including the floral meristems. The plant hormone auxin is produced in the shoot apical meristem. Among the many roles of auxin in plant development, it inhibits the production of lateral branches.

The term “lateral meristems” means the meristem in the vascular and cork cambia. Lateral meristems are known as secondary meristems because they are responsible for secondary growth or increase in stem girth and thickness. The term “intercalary meristem” means the meristem at the internodes or stem regions between the places at which leaves attach.

In accordance with the present method, an effective amount of a composition comprising one or more herbicides is applied to the shoot apical meristem of the plant. As used herein, the term “applying,” “applied,” “application,” or variations thereof, with reference to the composition means that the shoot apical meristem is contacted with the composition herein using any suitable means, e.g., sprayed, drenched, or misted. Various applicators may be used to apply the composition to the shoot apical meristem including, e.g., a hand-held aspirator-type sprayer or other commercial sprayer. Examples of commercial sprayers include the Hagie STS12, STS16 and STS20 models capable of carrying 1200, 1600, and 2000 gallons, respectively, of spray product. Such commercial sprayers may need to be modified with spray arms to target the shoot apical meristems from the upper side of the plants. In some aspects, the spray includes a pressurized nozzle, e.g., a nozzle having a psi of about 10, about 20, about 30, about 40, about 50, about 60, or more psi.

To effect overcompensation and an improvement in one or more agronomic traits of a plant, some aspects provide for the killing, damage, or inhibition of the growth of the shoot apical meristem at an appropriate time in the plant growth cycle. The removal, damage, or killing of a significant number of cells in, or inhibition to growth of the shoot apical meristem may occur between vegetative growth stage 1 (V1) and vegetative growth stage 6 (V6); or a period between vegetative growth stage 1 (V1) and vegetative growth stage 2 (V2); or a period between V2 and vegetative growth stage 3 (V3); or a period between V3 and vegetative growth stage (V4); or a period between V4 and vegetative growth stage 5 (V5); or a period between V5 and vegetative growth stage 6 (V6); or a period between V4 and V6; or at V1, V2, V3, V4, V5 or V6. In some aspects, removal of the shoot apical meristem results in minimal or no removal of adjacent V1 tissue if removing the apical meristem between V1 and V2, or minimal or no removal of adjacent V2 tissue if removing the apical meristem between V2 and V3, or minimal or no removal of adjacent V3 tissue if removing the apical meristem between V3 and V4, or minimal or no removal of adjacent V4 tissue if removing the apical meristem between V4 and V5, or minimal or no removal of adjacent V5 tissue if removing the apical meristem between V5 and V6. The selection of the optimal time for removal or inhibition of the growth of the shoot apical meristem may depend on the plant variety, geographic location, and environmental factors. Shoot apical meristem removal in this invention is by chemical means (e.g., application of one or more herbicides).

Depending, in part, on genetics, a plant selection, plant variety, inbred plant, or hybrid plant may not express overcompensation when cells in the shoot apical meristem are killed or their growth inhibited. Thus, plants may be screened to identify those capable of expressing overcompensation, e.g., by treatment of the shoot apical meristem with the composition described herein and measuring one or more agronomic traits to determine whether there is an increase in the one or more agronomic traits in the treated plant as compared to a plant not treated with the composition. Furthermore, the optimal time in the plant growth cycle for removal, or inhibition of growth, of the shoot apical meristem may be determined by treatment of the shoot apical meristem with the composition herein at V1, V2, V3, V4, V5 and V6 stages of growth and determining the stage in which there is an increase in one or more agronomic traits as compared to a plant not treated with the composition.

Alternatively, screening of plants and/or growth stage may be conducted at the molecular level. Increasing chromosome number through endoreduplication and therefore gene copy number provides a means of increasing expression of vital genes or genetic pathways that promote rapid regrowth rates following removal, damage, or inhibition of growth, of the apical meristem. Glucose-6-phosphate dehydrogenase (G6PD1) feeds compounds into the oxidative pentose phosphate pathway for nucleotide biosynthesis, by the provision of ribose-5-phosphate, necessary for the significant increase in chromosome number via endoreduplication. The increase in DNA content then feeds back positively on pathways involved in metabolism (e.g., G6PD1) and chemical defense. Endoreduplication leads to increased gene copy number and therefore increased gene expression. Accordingly, gene expression of one or more genes of these pathways may be measured to assess appropriate plants and/or growth stages of use in the methods described herein.

It is understood that a skilled person will be able to determine/identify the different growth stages of a particular crop concerned based upon conventional industry scales. Guidance for determining the growth stage of soybean (Glycine max L.) is provided by Soybean Growth Stages, published by the University of Illinois in 1999 (see, e.g., Najafikhan-Behbin, et al. (2019) Appl. Ecol. Environ. Res. 17(2):2911-2929) and McWilliam, et al. (1999) Soybean Growth and Management Quick Guide, A-1174, North Dakota State University, Frago, ND. Guidance for determining the growth stages of camelina (Camelina sativa) may be found in Martinelli & Glasso (2011) Annals Appl. Biol. 158:87-94. Guidance for determining the growth stages of peanut (Arachis hypogaea L.), cotton (Gossypium hirsutum L.), corn (Zea mays L.), canola (Brassica napus L.), sunflower (Helianthus annuus L.) and rice (Oryza sativa L.) may be found in Meier (2001) Biologische Bundesanstalt, Bundessortenamt and CHemical (BBCH) Monograph. The BBCH scale was developed to describe the stages of growth and development of monocotyledonous and dicotyledonous plants and uses a decimal code system, which is divided into principal and secondary growth stages. The BBCH scale is based on the cereal code system (Zadoks scale) developed by Zadoks et al. (1974) Weed Res. 14:415-421. Guidance for determining the growth stages of sorghum may be found at the Sorghum Checkoff Industry Organization (sorghumcheckoff.com/our-farmers/grain-production/growth-and-development/). The BBHC has also been specifically adapted for Solanum species such as S. tuberosum. See Hack et al. (1993) Das Nachtrichtenblatt des Deutschen Pflanzenschutzdientes 45(1):11-19. The BBCH scale for potato provides descriptions for true potato seed-grown and tuber-grown plants, wherein differences in the morphology of plants originating from the different plant materials in terms of types of branches and difference in below-ground growth and development are included. In some aspects, the description of potato plants and plant parts provided by Kacheyo et al. ((2021) Annals of Applied Biology 178(3):549-566) are used to identify the stage of growth when shoot apical meristems are removed, or shoot apical meristem growth is inhibited, to improve agronomic traits.

By way of illustration, removal, killing of a significant number of cells, or inhibition to growth of the shoot apical meristem of soybean (Glycine max L.) may occur between (i) growth stage 1 and growth stage 2, (ii) growth stage 2 and growth stage 3, (iii) growth stage 3 and growth stage 4, (iv) growth stage 4 and growth stage 5, or (v) growth stage 5 and growth stage 6. For soybeans, VE is the stage at which cotyledons emerge and supply energy for the plant for 7 to 10 days. VC is the stage soon after the cotyledons are fully exposed. At VC unifoliate leaves emerge at the second node and begin generating energy through photosynthesis. Growth state 1 or the V1 stage is when the first trifoliate leaflets form. The V2 stage (growth stage 2) is when the second trifoliate leaf is established. At V2 root nodules begin to develop. Nitrogen fixation by the plant begins to occur when the plants reach 6 to 8 inches in height. V3 (growth stage 3) is the stage when the third trifoliate leaf emerges. V4 (growth stage 4) is when the fourth trifoliate leaf emerges. V5 (growth stage 5) is when the fifth trifoliate leaf emerges. The V6 stage (growth stage 6) is when plants develop new growth stages about every 3 days depending on the environment. At this stage lateral roots should overlap in 30-inch rows or less. At R1 flowering begins on the third to sixth node and continues up and down the main stem. Flowering eventually moves to the branches. Nodes on the main stem usually have at least one flower. Vertical roots as well as secondary roots and root hairs continue to grow rapidly until R4 and R5. At stage R2 an open flower develops at one of the top two modes of the main stem. The plant has accumulated about 25% of its total dry weight and nutrients and about 50% of its mature height. Nitrogen fixation by root nodules increases rapidly at this stage. At stage R3 a pod on at least one of the upper four nodes is at least 3/16-inch long or longer. At stage R4 the pods are growing rapidly, and seeds are developing. At stage R5 at least one ⅛-inch-long seed is present in a pod at one of the four upper-most nodes. About half of the nutrients required for seed filling come from the plant's vegetative parts and about half from nitrogen fixation and nutrient uptake by the roots. Nitrogen fixation peaks at this stage. Stage R6 is known as the “green bean” stage because it marks the beginning of the full seed stage. At stage R7 at least one normal pod on the main stem reaches its mature brown or tan color. Seed dry matter begins to peak. Seeds and pods begin to lose green color. At stage R8 at least 95% of the pods on a plant have reached their mature color and the plant is fully mature. Typically, about 5 to 10 days of good drying weather after stage R8 is needed to obtain a harvest seed moisture content of less than 15%.

For corn (Zea mays), a composition as described herein may be applied to the shoot apical meristem of the corn between (i) growth stages 9 and 10, (ii) growth stages 10 and 11, (iii) growth stages 11 and 12, (iv) growth stages 12 and 13, (v) growth stages 13 and 14, (vi) growth stages 14 and 15, (vii) growth stages 15 and 16, (viii) growth stages 16 and 17, (ix) growth stages 17 and 18, (x) growth stages 18 and 19, or (xi) growth stages 19 and 30. Similar to dicots, growth stage of a monocot such as corn is when the first round-tipped leaf on first collar appears, and nodal roots elongate. By growth stage 2, the monocot may be 2 to 4 inches tall and rely on energy in the seed. Growth stage 3 begins 2 to 4 weeks after VE (emergence), and the plant switches from kernel reserves to photosynthesis and nodal roots begin to take over. Notably, in corn, a plant with 3 collars is considered growth stage 3, however, there may be 5 to 6 leaves showing on the plant. At the growth stage 4 stage, the fourth leaf collar is visible. At growth state 5-6, leaf collars are visible, the growing point is above the soil surface, the critical period of nitrogen uptake begins, and kernel row numbers are determined. See the Biologische Bundesanstalt, Bundessortenamt and Chemical (BBCH) scale for corn.

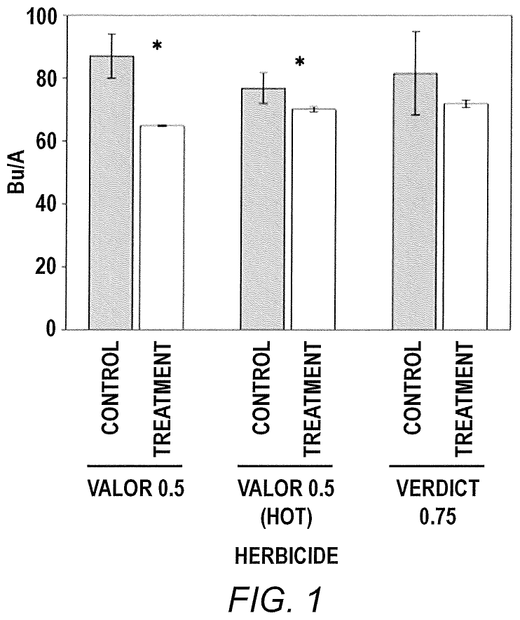

For tuber-grown potato plants, e.g., a tetraploid potato variety, a diploid inbred potato plant, or a diploid F1 hybrid potato plant, a composition as described herein may be applied after the first basal branches are formed, after the second basal branches are formed, after basal branches formed subsequent to the second basal branches are formed, after the last basal branches are formed but before the first sympodial branch is formed, after the first sympodial branch but before the second sympodial branch is formed, after the second sympodial branch is formed but before the third sympodial branch is formed, after the third sympodial branch is formed but before the fourth sympodial branch is formed, and/or after the fourth sympodial branch is formed but before the sixth sympodial branch is formed. See, e.g., FIG. 1(b) of Kacheyo et al. (2021) supra.

For true potato seed-grown potato plants, e.g., a tetraploid potato variety, a diploid inbred potato plant, or a diploid F1 hybrid potato plant, a composition as described herein may be applied after the first basal branches are formed before but before the second basal branches are formed, after the second basal branches are formed but before any subsequent basal branches are formed, after the last basal branches are formed but before the first sympodial branches are formed, after the first sympodial branches are formed but before the second sympodial branches are formed, after the second sympodial branches are formed but before the third sympodial branches are formed, after the third sympodial branches are formed but before the fourth sympodial branches are formed, and/or after the fifth sympodial branches are formed but before the sixth sympodial branches are formed. See, e.g., FIG. 1(a) of Kacheyo et al. (2021) supra.

After treatment of the plant with the composition described herein, the plant is grown for a sufficient amount of time to exhibit an improvement in one or more agronomic traits. In some aspects, the plant is grown to a stage when one or more commercially relevant portions of the plant are harvestable. The term “commercially relevant portion of the plant” refers to one or more portions of a plant that is obtained at some time during the plant growing cycle for direct or indirect consumption or in another application.

Accordingly, the method of the invention further includes the step of harvesting one or more commercially relevant portions of the plant. The commercially relevant portion of the plant may be a plant part such as a tuber, seed, seed pod, fruit, leaf, stem, root, or one or more chemicals or processed portions of the plant. A commercially relevant portion of the plant may be any of one or more natural plant products such as starch, oil, protein, carbohydrates, fiber, terpenes, wood, or the like.

In some aspects, the composition and method described herein include the use of one or more herbicides (e.g., 1, 2, 3, 4 or 5 herbicides). As used herein, the term “herbicide” refers to a substance used to kill, damage, suppress, or otherwise control unwanted plants, especially weeds. Herbicides may target specific plant processes such as photosynthesis, amino acid synthesis, or cell membrane integrity, and they can be selective (affecting certain plant species) or non-selective (affecting most vegetation). For the purposed herein, an herbicide is used to remove, damage, or inhibit the growth of the shoot apical meristem of a plant but does not damage, or does not significantly damage, kill, plant cells or tissues or inhibit the growth of plant cells or tissues other than those in the shoot apical meristem. Herbicides may be classified based on various factors including their mode of action, timing of application (pre-emergence or post-emergence), and/or the specific plants they target (selective or non-selective). Suitable herbicides of use in the compositions and methods herein include without limitation those listed in Table 1. In some aspects, a composition comprising one or more herbicides and excludes the use of lactofen.

The phrase “active ingredient that is an herbicide” refers to the specific chemical component in an herbicide product that is responsible for the weed-control activity. While a formulated herbicide product may contain solvents, surfactants, or carriers, the active ingredient is the part that exerts the biological effect on plants. It is the compound that disrupts a biochemical or physiological process in weeds, resulting in growth inhibition or death.

The phrase “commercial herbicide” refers to a formulated product sold for use in agricultural, landscaping, industrial, or residential settings to control unwanted vegetation. Unlike a pure active ingredient, a commercial herbicide contains the herbicidal active ingredient plus additional components—such as solvents, surfactants, carriers, stabilizers, or adjuvants—that make the product effective, safe, and practical to handle, mix, and apply. Commercial herbicides are manufactured to meet regulatory standards, labeled with legally required directions for use, and designed for reliable performance under real-world conditions.

TABLE 1

| | | |
|---|---|---|
| Site of Action | Chemical Family | Active Ingredient |

Lipid Synthesis Inhibitors

| | | |
|---|---|---|
| ACCase Inhibitors | Aryloxyphenoxy propionate | fenoxaprop, fluazfop, |
| (Acetyl CoA | | quizalofop |
| Carboxylase) | Cyclohexanedione | Clethodim, sethoxydim |

Amino Acid Synthesis Inhibitors

| | | |
|---|---|---|
| ALS Inhibitors | Sulfonylurea | chlorimuron, foramsulfuron, |
| (Acetolactate Synthase) | | halosulfuron, iodosulfuron, |
| | | nicosulfuron, primisulfuron, |
| | | prosulfuron, timsulfuron, |
| | | thifensulfuron, tribenuro |
| | Imidazolinone | imazamox, |
| | | imazaquin, imazapyr, |
| | | imazethapyr |
| | Trizoloyrimidine | flumetsulam, cloransulam, |
| | | thiencarbazone |
| | Triazoloyrimidine | thiencarbazone |
| EPSP (5-Enolpyruvyl- | — | glyphosate |
| Shikimate-3-Phosphate) | | |
| Synthase Inhibitor | | |

Growth Regulators

| | | |
|---|---|---|
| — | Phenoxy | 2,4-D |
| | Benzoic acid | dicamba |
| | Carboxylic acid | Clopyalid, fluroxypyr |
| Auxin Transport | Semicarbazone | difufenzopyr |
| Inhibitors | | |

Photosynthesis Inhibitors

| | | |
|---|---|---|
| Photosystem II | Triazine | atrazine, simazine |
| Inhibitors | Triazinone | metribuzin |
| | Nitrile | bromoxynil |
| | Benzothiadiazole | bentazon |
| | Ureas | linuron |

Nitrogen Metabolism

| | | |
|---|---|---|
| Glutamine Synthase | — | glufosinate |
| Inhibitor | | |

Pigment Inhibitors

| | | |
|---|---|---|
| Diterpene Synthesis | Isoxazolidinone | clomazone |
| Inhibitor | | |
| HPPD (4- | Isoxazole, Pyrazolone, | isoxaflutole, topramezone, |
| Hydroxyphenyl- | Triketone | mesotrione, tembotrione |
| Pyruvate Dioxygenase) | | |
| Inhibitors | | |

Cell Membrane Disrupters

| | | |
|---|---|---|
| | Diphenylether | acifluorfen, fomesafen, |
| | | lactofen |
| PPO (Proto- | N-phenylphthalimide | flumiclorac |
| Porphyrinogen | Aryl triazinone | Sulfentrazone, carfentrazone, |
| Oxidase) Inhibitors | | fluthiacet-ethyl |
| | Pyrimidinedione | saflufenacil |
| Photosystem I Electron | Bipyridilium | paraquat |
| Diverter | | |

Seedling Root Growth Inhibitors

| | | |
|---|---|---|
| Microtubule Inhibitors | Dinitroaniline | Ethalfluralin, pendimethalin, |
| | | trifluralin |
| Lipid Synthesis | Thiocarbamate | Butylate, EPTC (S-ethyl |
| Inhibitors (not ACCase) | | dipropylthiocarbamate) |
| Long-Chain Fatty Acid | Chloroacetamide | acetochlor, alachlor, |
| Inhibitor | | metolachlor, dimethenamid |
| | Oxyacetamide | flufenacet |
| | Pyrazole | pyroxasulfone |

In some aspects, the one or more active ingredient that are herbicides used in a composition and/or a method described herein is a lipid synthesis inhibitor, amino acid synthesis inhibitor, growth regulator, photosynthesis inhibitor, nitrogen metabolism inhibitor, pigment inhibitor, cell membrane disruptor, seedling root growth inhibitor, a seedling shoot-growth inhibitor or a combination thereof.

In some aspects, the one or more active ingredient that are herbicides used in a composition and/or a method described herein is an acetyl CoA carboxylase inhibitor, ALS inhibitor, EPSP synthase inhibitor, auxin transport inhibitor, photosystem II inhibitor, glutamine synthase inhibitor, diterpene synthesis inhibitor, HPPD inhibitor, PPO inhibitor, photosystem I electron diverter, microtubule inhibitor, non-ACCase lipid synthesis inhibitor, a long-chain fatty acid synthesis inhibitor, or a combination thereof.

In some aspects, the one or more active ingredient that are herbicides used in a composition and/or a method described herein is an aryloxyphenoxy propionate, cyclohexanedione, sulfonylurea, imidazolinone, trizoloyrimidine, triazoloyrimidine, phenoxy, benzoic acid, carboxylic acid, semicarbazone, triazine, triazinone, nitrile, benzothiadiazole, urea, isoxazolidinone, isoxazole, pyrazolone, triketone, diphenylether, N-phenylphthalimide, aryl triazinone, pyrimidinedione, bipyridilium, dinitroaniline, thiocarbamate, chloroacetamide, oxyacetamide, pyrazole, or a combination thereof.

In some aspects, the one or more active ingredient that are herbicides used in a composition and/or method described herein is flumioxazin, saflufenacil, diflufenapyr, triclopyr, fenoxaprop, fluazfop, quizalofop, clethodim, sethoxydim, chlorimuron, foramsulfuron, halosulfuron, iodosulfuron, nicosulfuron, primisulfuron, prosulfuron, timsulfuron, thifensulfuron, tribenuro, imazamox, imazaquin, imazapyr, imazethapyr, flumetsulam, cloransulam, thiencarbazone, thiencarbazone, glyphosate, 2,4-D, dicamba, clopyalid, fluroxypyr, difufenzopyr, atrazine, simazine, metribuzin, bromoxynil, bentazon, linuron, glufosinate, clomazone, isoxaflutole, topramezone, mesotrione, tembotrione, acifluorfen, fomesafen, lactofen, flumiclorac, sulfentrazone, carfentrazone, fluthiacet-ethyl, saflufenacil, paraquat, ethalfluralin, pendimethalin, trifluralin, butylate, EPTC, acetochlor, alachlor, metolachlor, dimethenamid, flufenacet, pyroxasulfone, or a combination thereof. In some aspects, when a composition and/or method herein consists of a single herbicide, the single herbicide is not lactofen. In some aspects, when a composition and/or a method disclosed herein comprises a combination of herbicides, lactofen may be included to induce overcompensation.

Some of the active ingredient that are herbicides disclosed above are obtained commercially under the trade names COBRA®, VALOR®, SHARPEN®, Verdict®, STATUS®, STINGER®, ENLIST®, CROSSBOW®, KYRO, and SURTAIN®. The compositions disclosed herein contemplate the use of a single active ingredient that is an herbicide, or a combination of one or more active ingredient that are herbicides. Also encompassed within the scope of the present disclosure are compositions comprising one or more active ingredient that are herbicides and an additional chemical agent known to induce overcompensation in plants. Examples of chemical agents known to induce overcompensation in plants without limitations are saturated and unsaturated C₈-C₂₀ fatty acids and their corresponding methyl or ethyl esters, saturated and unsaturated C₈-C₂₀ lipid alcohols, methylated seed oil (MSO), B-100 (a biofuel), PEG-COOH, and PEG-OH. The compositions disclosed herein can further comprise chemical agents such as urea ammonium nitrate, ammonium thiosulfate, as well as plant growth regulators such as ATRIMEC, BONZI, or PROMALIN. In one embodiment, the herbicide composition further comprises 200 ounces of MSO and 100 ounces of 32% UAN. Such compositions are denoted as “hot” in the present application.

In one embodiment, the composition comprises VALOR® 0.5, 200 ounces of MSO and 100 ounces of 32% UAN. In one embodiment, the composition comprises COBRA® 12, 200 ounces of MSO, and 100 ounces of 32% UAN. In another embodiment, the composition comprises COBRA® 6, 200 ounces of MSO, and 100 ounces of 32% UAN.

It is well within the skill of the art to determine the proper concentration of any active ingredient that is an herbicide and apply it at the proper time in the growth cycle of the plant, to induce overcompensation. An effective amount of an active ingredient that is an herbicide used to kill, damage, or inhibit the growth of the shoot apical meristem of a plant, without causing significant damage to other plant tissues, may be determined by titrating the concentration of the one or more active ingredient that are herbicides in the composition. The concentration of the active ingredient that is an herbicide and time of application may vary depending on a wide variety of factors including, but not limited to, plant species, plant variety, plant selection, plant hybrid, and plant growing conditions.

In some aspects, the one or more active ingredient that are herbicides used in a composition and/or a method described herein include, but are not limited to, glyphosate, atrazine, 2,4-D, dicamba, imazapyr, pendimethalin, metolachor, and/or mesotrione.

In some embodiments, the one or more active ingredient that are herbicides is applied to a plant at a rate of about 0.1 ounces/acre (oz/acre), to about 20 oz/acre. According to one embodiment, the herbicide composition is applied at a rate of 0.1 oz/acre, 0.15 oz/acre, 0.2 oz/acre, 0.25 oz/acre, 0.3 oz/acre, 0.35 oz/acre, 0.375 oz/acre, 0.4 oz/acre, 0.45 oz/acre, 0.5 oz/acre, 0.6 oz/acre, 0.7 oz/acre, 0.8 oz/acre, 0.9 oz/acre, 1.0 oz/acre, 1.5 oz/acre, 2.0 oz/acre, 2.5 oz/acre, 3.0 oz/acre, 4.0 oz/acre, 5.0 oz/acre, 6.0 oz/acre, 7.0 oz/acre, 8.0 oz/acre, 9.0 oz/acre, 10.0 oz/acre, 11.0 oz/acre, 12.0 oz/acre, 15.0 oz/acre, or 20.0 oz/acre. It is understood that the application rate of a composition comprising one or more herbicides can be applied to a plant at a rate equal to any value or range derivable from that mentioned above.

In one embodiment, the concentration of the active ingredient that is an herbicide in a composition is expressed in units of Molarity, which corresponds to (moles of herbicide or active ingredient)/(volume of solvent in liter). In some embodiments, the concentration of the herbicide and/or the active ingredient (AI) in a composition is expressed as millimolar (mM), which corresponds to one-one thousandth (1/1000) of molar. For instance, the concentration of the herbicide and/or the active ingredient (AI) in a composition is in a range from about 0.00001M (0.01 mM) to about 0.02M (20 mM). In one embodiment, the concentration of the herbicide and/or the active ingredient (AI) in a composition is about 0.01 mM, 0.02 mM, 0.03 mM, 0.04 mM, 0.05 mM, 0.06 mM, 0.07 mM, 0.08 mM, 0.09 mM, 0.1 mM, 0.2 mM, 0.3 mM, 0.4 mM, 0.5 mM, 0.6 mM, 0.7 mM, 0.8 mM, 0.9 mM, 1.0 mM, or any value therebetween. In one embodiment, the concentration of the herbicide and/or the active ingredient (AI) in a composition is the range from about 1.0 mM to about 2.0 mM, from about 2.0 mM to about 3.0 mM, from about 3.0 mM to about 4.0 mM, from about 4.0 mM to about 5.0 mM, from about 5.0 mM to about 6.0 mM, from about 6.0 mM to about 7.0 mM, from about 7.0 mM to about 8.0 mM, from about 8.0 mM to about 9.0 mM, or from about 9.0 mM to about 10.0 mM.

Alternatively, in some embodiment, the amount of the active ingredient that is an herbicide in a composition is expressed in ounces, pounds, quarts, pints, or fluid ounces. If expressed in these units, the amount of the active ingredient that is an herbicide in a composition is converted to grams using conversion factors that are known to the skilled person in the relevant art. The concentration of the active ingredient that is an herbicide can be converted to molarity using the appropriate molecular weight and such conversions are known to the skilled person in the art.

Additionally the amount of the chemical agent known to induce overcompensation in a composition of the invention can be in the range from about 0.1% to about 20%, for instance in the range from about 0.1% to about 15%, in the range from about 0.1% to about 10%, in the range from about 0.1% to about 9.0%, in the range from about 0.1% to about 8.0%, in the range from about 0.1% to about 7.0%, in the range from about 0.1% to about 6.0%, in the range from about 0.1% to about 5.0%, in the range from about 0.1% to about 4.0%, in the range from about 0.1% to about 3.0%, in the range from about 0.1% to about 2.0%, in the range from about 0.1% to about 1.0%, or any value or range derivable therein.

In some aspects, the one or more herbicides comprises glyphosate. For weed control, the rate of application of glyphosate may be 0.75 pounds (12 ounces) of acid equivalent per acre. In some aspects, when used in a composition and/or a method described herein, glyphosate may be used at a rate of application equal to or less than about 0.75 pounds (12 ounces) of acid equivalent per acre, e.g., about 0.75, 0.70, 0.65, 0.60, 0.55, 0.50, 0.45, 0.40, 0.35, 0.30, 0.25, 0.20, 0.15, or 0.10 pounds of acid equivalent per acre, or any value or range therebetween.

In some aspects, the one or more herbicides comprises atrazine. For weed control, the application rate of atrazine maybe 1-2 pounds (16-32 ounces) active ingredient per acre. In some aspects, when used in a composition and/or method herein, atrazine may be used at a rate of application equal to or less than about 1-2 pounds (16-32 ounces) active ingredient per acre, e.g., about 2.0, 1.5, 1.0, 0.5, 0.25 pounds, or 0.1 pounds active ingredient per acre, or any value or range therebetween.

In some aspects, the active ingredients that are one or more herbicides comprises 2,4-Dichlorophenoxyacetic acid (2,4-D), a systemic herbicide that kills broadleaf weeds and triclopyr is an herbicide that mimics the action of the plant growth hormone auxin. For weed control, the application rate of 2,4-D may be 1-4 pints (i.e., 16-64 fluid ounces) of active ingredient per acre. In some aspects, when used in a composition and/or method herein, atrazine may be used at a rate of application equal to or less than about 1-4 pints (i.e., 16-64 fluid ounces) of active ingredient per acre, e.g., about 4.0, 3.5. 3.0, 2.5, 2.0, 1.5, 1.0, 0.5, 0.25 pints, or 0.1 pints active ingredient per acre, or any value or range therebetween. Alternatively, application rates of this herbicide composition can vary, from about 0.1 oz/acre to about 15 oz/acre or any value or range therebetween, in one embodiment the composition was applied to soybean plants at a rate of 0.25 oz/acre.

In some aspects, the one or more herbicides comprises dicamba. For weed control, the application rate of dicamba may be 0.25-1.0 pints (i.e., 16-64 fluid ounces) of active ingredient per acre. In some aspects, when used in a composition and/or method herein, dicamba may be used at a rate of application equal to or less than about 0.25-1.0 pints active ingredient per acre, e.g., about 1.0, 0.9, 0.8, 0.7, 0.6, 0.5, 0.4, 0.3, 0.2, or 0.1 pints of active ingredient per acre, or any value or range therebetween.

In some aspects, the one or more herbicides comprises imazapyr. For weed control, the rate of application of imazapyr may be about 1.5 pounds (i.e., 24 ounces) per acre. In some aspects, when used in a composition and/or method herein, imazapyr may be used at a rate of application equal to or less than about 1.5 pounds (24 ounces) of acid equivalent per acre, e.g., about 1.5, 1.4, 1.3, 1.2, 1.1, 1.0, 0.9, 0.8, 0.7, 0.6, 0.5, 0.4, 0.3, 0.2, or 0.1 pounds per acre, or any value or range therebetween.

In some aspects, the one or more herbicides comprises pendimethalin. For pre-emergence control of weeds, the rate of application of pendimethalin may be about 2-4 pints (i.e., 32-64 fluid ounces) per acre. In some aspects, when used in a composition and/or method herein, pendimethalin may be used at a rate of application equal to or less than about 2-4 pints active ingredient per acre, e.g., about 4.0, 3.5. 3.0, 2.5, 2.0, 1.5, 1.0, 0.5, 0.25, or 0.1 pints of active ingredient per acre, or any value or range therebetween.

In some aspects, the one or more herbicides comprises metolachlor. For weed control, the application rate of metolachlor may be 1-2 pints (i.e., 16-32 fluid ounces) of active ingredient per acre. In some aspects, when used in a composition and/or method herein, metolachlor may be used at a rate of application equal to or less than about 1-2 pints active ingredient per acre, e.g., about 2.0, 1.5, 1.0, 0.5, 0.25, or 0.1 pints of active ingredient per acre, or any value or range therebetween.

In some aspects, the one or more herbicides comprises mesotrione. For weed control, the application rate of mesotrione may be 3-8 fluid ounces active ingredient per acre. In some aspects, when used in a composition and/or method herein, mesotrione may be used at a rate of application equal to or less than about 3-8 fluid ounces active ingredient per acre, e.g., about 8.0, 7.5, 7.0, 6.5, 6.0, 5.5, 5.0, 4.5, 4.0, 3.5, 3.0, 2.5, 2.0, 1.5, 1.0, 0.5, 0.25, or 0.1 fluid ounces active ingredient per acre, or any value or range therebetween.

In some aspects, a composition herein comprises lactofen. For weed control in soybean, the application rate of lactofen may be 12.5-20 fluid ounces active ingredient per acre. In some aspects, when used in a composition and/or method herein, lactofen may be used at a rate of application equal to or less than about 12.5-20 fluid ounces active ingredient per acre, e.g., about 20.0, 19.0, 18.0, 17.0, 16.0, 15.0, 14.0, 13.0, 12.0, 11.0, 10.0, 9.0, 8.0, 7.5, 7.0, 6.5, 6.0, 5.5, 5.0, 4.5, 4.0, 3.5, 3.0, 2.5, 2.0, 1.5, 1.0, 0.5, 0.25, or 0.1 fluid ounces active ingredient per acre, or any value or range therebetween. In one embodiment, the rate of application of a composition comprising 2.0 pounds/gallon of lactofen is about 6.0 oz/acre. In one embodiment, the rate of application of a composition comprising 2.0 pounds/gallon of lactofen is about 12.0 oz/acre.

In some aspects, a composition and/or methods described herein includes the use of a combination of S-metolachlor, mesotrione, and atrazine. A commercial product that includes these three active ingredients is sold under the tradename LEXAR EZ® (Syngenta). Application rates may vary based on the specific crop, soil type, and target weeds. For weed control in corn, rates may range from 2.5-3.5 quarts (80-112 fluid ounces) per acre. In some aspects, when used in a composition and/or method herein, the combination of S-metolachlor, mesotrione, and atrazine sold under the tradename LEXAR EZ® may be used at a rate of application equal to or less than about 2.5-3.5 quarts (80 -112 fluid ounces) per acre, e.g., about 3.5, 3.0, 2.5, 2.0, 1.5, 1.0, 0.75, 0.5, 0.25, or 0.1 quarts per acre, or any value or range therebetween.

In some aspects, a composition and/or methods described herein comprises inhibitors of the enzyme protoporphyrinogen oxidase (PPO). Protoporphyrinogen oxidase (PPO) inhibitors are herbicides that disrupt chlorophyll and heme biosynthesis by blocking the PPO enzyme. The PPO enzyme is a key catalyst in the tetrapyrrole pathway. When PPO is inhibited, its substrate protoporphyrinogen IX, accumulates and spontaneously oxidizes to protoporphyrin IX. Protoporphyrin IX is a potent photosensitizer. In the presence of light, protoporphyrin IX generates reactive oxygen species that rapidly damage cell membranes through lipid peroxidation. The disruption of cell membranes leads to cellular leakage, desiccation, and ultimately plant death. Because the damage is driven by light-induced oxidative stress, PPO inhibitors typically cause very fast symptom development, including leaf necrosis and bronzing within hours of application.

In some aspects, a composition and/or methods described herein comprises flumioxazin, a PPO inhibitor, which is a broad-spectrum herbicide used to control weeds in crops like soybeans and peanuts, as well as in non-crop areas and aquatic environments. This N-phenylphthalimide herbicide acts quickly on contact. Compositions comprising this herbicide are applied at a rate, based on the specific crop, soil type, and target weeds, in a range from about 0.1 oz/acre to about 15 oz/acre. In some embodiments, the rates varies and may be used at about 0.1 oz/acre, about 0.2 oz/acre, about 0.3 oz/acre, about 0.4 oz/acre, about 0.5 oz/acre, about 0.6 oz/acre, about 0.7 oz/acre, about 0.8 oz/acre, about 0.9 oz/acre, about 1.0 oz/acre, about 1.5 oz/acre, about 2.0 oz/acre, about 2.5 oz/acre, about 3.0 oz/acre, about 3.5 oz/acre, about 4.0 oz/acre, about 4.5 oz/acre, about 5.0 oz/acre, about 6.0 oz/acre, about 7.0 oz/acre, about 8.0 oz/acre, about 9.0 oz/acre, about 10.0 oz/acre, about 11.0 oz/acre, about 12.0 oz/acre, about 13.0 oz/acre, about 14.0 oz/acre, about 15.0 oz/acre, or any value or range derivable therebetween.

In some aspects, a composition and/or methods described herein comprises saflufenacil. Saflufenacil is a pyrimidinedione-class herbicide used to control broadleaf weeds in crops like soybeans and corn. It works by inhibiting the enzyme protoporphyrinogen oxidase (PPO), which disrupts the formation of cell membranes. In one embodiment, the rate of application of a composition comprising 2.85 pounds/gallon of saflufenacil may be about 0.15 oz/acre. In one embodiment, the rate of application of a composition comprising 2.85 pounds/gallon of saflufenacil may be about 0.75 oz/acre.

In one embodiment, the composition is a mixture of saflufenacil and dimethenamid, a selective, pre-emergent herbicide from the chloroacetamide class, used to control grasses and broadleaf weeds in crops like field corn. It works by inhibiting the synthesis of long-chain fatty acids, which stops plant cell division and growth. The more active isomer is called Dimethenamid-P, which can be used at lower rates.

In an embodiment, the composition comprises saflufenacil and dimenthenamid, may be applied at a rate, based on the specific crop, soil type, and target weeds, in a range from about 0.1 oz/acre to about 15 oz/acre. In some embodiments, the rates varies and may be about 0.1 oz/acre, about 0.2 oz/acre, about 0.3 oz/acre, about 0.4 oz/acre, about 0.5 oz/acre, about 0.6 oz/acre, about 0.7 oz/acre, about 0.8 oz/acre, about 0.9 oz/acre, about 1.0 oz/acre, about 1.5 oz/acre, about 2.0 oz/acre, about 2.5 oz/acre, about 3.0 oz/acre, about 3.5 oz/acre, about 4.0 oz/acre, about 4.5 oz/acre, about 5.0 oz/acre, about 6.0 oz/acre, about 7.0 oz/acre, about 8.0 oz/acre, about 9.0 oz/acre, about 10.0 oz/acre, about 11.0 oz/acre, about 12.0 oz/acre, about 13.0 oz/acre, about 14.0 oz/acre, about 15.0 oz/acre, or any value or range therebetween. In one embodiment, the rate of application of a composition comprising 0.57 pounds/gallon of saflufenacil and 5 pounds/gallon of dimethenamid may be about 0.75 oz/acre.

In one embodiment, the composition comprises saflufenacil and pyroxasulfone, a pre-emergence herbicide used for controlling a range of annual grasses and broadleaf weeds in crops like corn and soybeans. It works by inhibiting the very long-chain fatty acid (VLCFA) biosynthesis in plants, preventing shoot elongation, and is typically applied before or during sowing. While application rates of these herbicides may vary, based on the specific crop, soil type, and target weeds, for weed control the applied rate can vary in a range from about 0.1 oz/acre to about 15 oz/acre. In some embodiments, the rates varies and is about 0.1 oz/acre, about 0.2 oz/acre, about 0.3 oz/acre, about 0.4 oz/acre, about 0.5 oz/acre, about 0.6 oz/acre, about 0.7 oz/acre, about 0.8 oz/acre, about 0.9 oz/acre, about 1.0 oz/acre, about 1.5 oz/acre, about 2.0 oz/acre, about 2.5 oz/acre, about 3.0 oz/acre, about 3.5 oz/acre, about 4.0 oz/acre, about 4.5 oz/acre, about 5.0 oz/acre, about 6.0 oz/acre, about 7.0 oz/acre, about 8.0 oz/acre, about 9.0 oz/acre, about 10.0 oz/acre, about 11.0 oz/acre, about 12.0 oz/acre, about 13.0 oz/acre, about 14.0 oz/acre, about 15.0 oz/acre, or any value or range derivable therebetween.

In one embodiment, the rate of application of a composition comprising 0.626 pounds/gallon of saflufenacil and 1.0 pounds/gallon of pyroxasulfone may be about 1.0 oz/acre. In another embodiment, the rate of application of a composition comprising 0.626 pounds/gallon of saflufenacil and 1.0 pounds/gallon of pyroxasulfone may be about 2.0 oz/acre.

Diflufenzopyr is another herbicide used to selectively control broadleaf weeds by inhibiting the plant hormone auxin, which disrupts plant growth. It is often combined with dicamba in products like Overdrive. In one embodiment, the composition comprises Diflufenzopyr and dicamba, a systemic herbicide for weed control. While application rates of these herbicides may vary, based on the specific crop, soil type, and target weeds, for weed control the applied rate can vary in a range from about 0.1 oz/acre to about 15 oz/acre. In some embodiments, the rates varies and may be about 0.1 oz/acre, about 0.2 oz/acre, about 0.3 oz/acre, about 0.4 oz/acre, about 0.5 oz/acre, about 0.6 oz/acre, about 0.7 oz/acre, about 0.8 oz/acre, about 0.9 oz/acre, about 1.0 oz/acre, about 1.5 oz/acre, about 2.0 oz/acre, about 2.5 oz/acre, about 3.0 oz/acre, about 3.5 oz/acre, about 4.0 oz/acre, about 4.5 oz/acre, about 5.0 oz/acre, about 6.0 oz/acre, about 7.0 oz/acre, about 8.0 oz/acre, about 9.0 oz/acre, about 10.0 oz/acre, about 11.0 oz/acre, about 12.0 oz/acre, about 13.0 oz/acre, about 14.0 oz/acre, about 15.0 oz/acre, or any value or range derivable therebetween. In one embodiment, the rate of application of a composition that comprises 16% Diflufenzopyr and 40% dicamba may be about 0.1 oz/acre. In some embodiments, the rate of application may be about 0.2 oz/acre to about 2.0 oz/acre.

Sulfentrazone broad-spectrum herbicide. It acts by inhibiting the enzyme protoporphyrinogen oxidase. Sulfentrazone can be used both pre- and post-emergence and is rapidly metabolized by soybean at the methyl group of the triazolinone ring, which confers a level of safety to that crop. Sulfentrazone is authorized for the removal of sedges and newly emerged broadleaf weeds including purple and yellow nutsedge, Kyllinga. Compositions comprising Sulfentrazone (4 pounds/gallon) may be applied to plants at a rate of 2.0 oz/acre. In some embodiments, the application rates may be varied based on the specific crop, soil type, and target weeds, and may range from about 0.1 oz/acre to about 15 oz/acre. In some embodiments, the rates varies and may be about 0.1 oz/acre, about 0.2 oz/acre, about 0.3 oz/acre, about 0.4 oz/acre, about 0.5 oz/acre, about 0.6 oz/acre, about 0.7 oz/acre, about 0.8 oz/acre, about 0.9 oz/acre, about 1.0 oz/acre, about 1.5 oz/acre, about 2.0 oz/acre, about 2.5 oz/acre, about 3.0 oz/acre, about 3.5 oz/acre, about 4.0 oz/acre, about 4.5 oz/acre, about 5.0 oz/acre, about 6.0 oz/acre, about 7.0 oz/acre, about 8.0 oz/acre, about 9.0 oz/acre, about 10.0 oz/acre, about 11.0 oz/acre, about 12.0 oz/acre, about 13.0 oz/acre, about 14.0 oz/acre, about 15.0 oz/acre, or any value or range derivable therebetween.

In addition to one or more herbicides, a composition and/or method herein may further include the use of one or more surfactants, fungicides, bactericides, and/or pesticides. The selection of the appropriate surfactant(s), fungicide(s), bactericide(s), and/or pesticide(s) may be readily determined by methods well known to the skilled artisan and may vary depending on the plant species, geographic region, environmental factors, and other factors. Likewise, the appropriate concentration of the surfactant(s), fungicide(s), bactericide(s), and/or pesticide(s) may vary and may be readily and empirically determined by methods well known to the skilled artisan and/or using concentrations recommended by the manufacturer depending on the plant species, geographic region, environmental factors, and other factors.

In some aspects, a composition and/or method herein may further include the use of one or more surfactants (e.g., 1, 2, 3, 4, or 5 surfactants). As used herein, the term “surfactant” or “emulsifier” describes a chemical substance that acts as a stabilizer for emulsions, preventing liquids that are immiscible with one another from separating, typically by increasing the kinetic stability of the emulsion by, e.g., lowering the interfacial tension between the liquids. In some aspects, the surfactant is an inert component of the composition. In some aspects, the one or more surfactants are polyoxyethylene sorbitan monoesters, such as the laurates, palmitates, stearates, and oleates. The preferred average number of oxyethylene groups per molecule may be about 20, although sorbitan monoesters containing from about 10 to about 30 oxyethylene groups per molecule are similarly useful. In some aspects, the one or more fatty acids include one or more polyoxyethylene sorbitan esters, polyoxyethylene alcohols, alkylarylpolyether alcohols, phthalic glycerol alkyl resins, ethoxylated imidazoline, decanoic acid, diglycol oleate, polyether sulfonates, alkylaryl sulfonates, and mixtures thereof.

Exemplary surfactants for use in a composition and/or method for removing or inhibiting the growth of the shoot apical meristem of a plant include, but are not limited to, TWEEN® 20 (polyoxyethylene (20) sorbitan monolaurate), TWEEN® 21 (polyoxyethylene (4) sorbitan monolaurate), TWEEN® 40 (polyoxyethylene (2) sorbitan monopalmitate), TWEEN® 60 (polyoxyethylene (20) sorbitan monostearate), TWEEN® 80 (polyoxyethylene (20) sorbitan monooleate), ACL-429 (ethoxylated imidazoline), G 1288 (polyoxyethylene fatty glyceride), G 1300 (polyoxyethylene fatty glyceride), and/or Tergitol 12-P-12 (polyoxyethylene (12) dodecylophenol). The concentration of the surfactant in a composition herein may be about 0.01 M to about 10.0 M (e.g., 0.01, 0.015, 0.025, 0.03, 0.035, 0.04, 0.045, 0.05, 0.055, 0.06, 0.07, 0.08, 0.09, 0.1, 0.2, 0.3, 0.4, 0.5, 0.6, 0.7, 0.8, 0.9, 1.0, 2.0, 3.0, 4.0, 5.0, 6.0, 7.0, 8.0, 9.0, 10.0 M, or any concentration or range therebetween). In some aspects, the surfactant component of the composition is in the range of about 5% to about 60% (e.g., about 5%, 10%, 15%, 20%, 25%, 30%, 35%, 40%, 45%, 50%, 55%, or 60%) by weight of the composition. In some aspects, the total weight of the one or more surfactants in the composition is approximately equal to the total weight of the one or more herbicides in the composition.

For some compositions, the ratio of one or more herbicide to a surfactant may be in the range from about 0.1:10 to about 10:0.1 or any value or range derivable therein. In some applications, the ratio of herbicide:surfactant may be 0.1:1, 0.5:1, 1;1, 1.5:1, 2:1, 5:1, 10:1, 1:0.5, or 1:0.1.

In some aspects, a composition and/or method herein may further include the use of one or more fungicides. Exemplary fungicides for use in a composition and/or method for removing or inhibiting the growth of the shoot apical meristem of a plant include, but are not limited to, chlorothalonil, copper-based fungicides (e.g., Bordeaux mixture, copper hydroxide, or copper sulfate), mancozeb, azoxystrobin, pyraclostrobin, Bacillus subtilis, trifloxystrobin, tebuconazol, propiconazole, myclobutanil, cyprodinil, fenhexamid, thiophanate-methyl, captan, and/or difenoconazole.

In some aspects, a composition and/or method herein may further include the use of one or more bactericides. Exemplary bactericides for use in a composition and/or method for removing or inhibiting the growth of the shoot apical meristem of a plant include, but are not limited to, copper-based bactericides (e.g., Bordeaux mixture, copper hydroxide, copper sulfate), streptomycin sulfate, oxytetracycline, Bacillus subtilis, Bacillus amyloliquefaciens, Pseudomonas fluorescens, hydrogen dioxide (hydrogen peroxide), peroxyacetic acid (peracetic acid), sodium hypochlorite (bleach, when properly diluted), and/or quaternary ammonium compounds.

In some aspects, a composition and/or method herein may further include the use of one or more pesticides. Exemplary pesticides for use in a composition and/or method for removing or inhibiting the growth of the shoot apical meristem of a plant include, but are not limited to, copper-based pesticides (e.g., copper sulfate, copper hydroxide), Bacillus thuringiensis (a biological control for various caterpillar pests), Spinosad (derived from the soil bacterium Saccharopolyspora spinosa and effective against a range of pests like caterpillars, thrips, and leafminers), neem oil (derived from the seeds of the neem tree and effective against various pests and fungi), pyrethrin (derived from chrysanthemum flowers, effective against a broad range of insects), insecticidal soaps (potassium salts of fatty acids and effective against soft-bodied pests like aphids and whiteflies, horticultural oils (highly refined petroleum oils or plant-based oils effective against a variety of pests and some diseases), diatomaceous earth (composed of crushed diatom fossils, and effective against crawling insects, biological fungicides (microbial-based products like Bacillus subtilis, Trichoderma spp., and/or Streptomyces spp.

The following examples are provided for illustrative purposes only and not intended to limit the scope of the claims.

### Example 1: General Protocol for Field Trials

Experiments were conducted in a randomized design that included between 2 and 4 replications depending on the study. The soil was primarily Drummer silty-clay loam (Fine-silty, mixed, superactive, mesic Typic Endoaquolls) with inclusions of Flanagan silt loam (Fine, smectitic, mesic Aquic Argiudolls).

Plot size was approximately 3 m by 9.1 m. Soybeans were planted at approximately 271,000 to 395,000 seeds ha⁻¹ planted in rows spaced 0.76m apart following preplant tillage to prepare a weed-free site at trial establishment. Weeds were controlled with a preplant application (PRE) of soil-active herbicides and postemergence (POST) with a mix of glyphosate and glufosinate.

Herbicides and other materials (including liquid fertilizers, methyl esters etc.) were applied POST with a CO₂-pressurized backpack sprayer equipped with AIXR 110025 Teejet Air Induction XR nozzles (TeeJet Technologies, Glendale Heights, IL, USA) for POST applications.

Nozzles were spaced 50 cm apart held at either 15-cm (banded) or 46-cm above applications to the soybean canopy and calibrated to deliver 187 L/ha at 5.6 km h⁻¹ and 248 kPa. Application timings were between the V3 and V5 growth stages.

Foliar injury ratings were made 7 and 14 days after treatment. Average soybean plant height was measured following leaf drop. Final yield was measured using a calibrated plot combine that harvested a 2-row strip approximately 8.2 meters long.

Using the experimental protocol described above, formulations of the following active ingredients that are herbicides were applied onto soybean plants. The data is shown in Table 2. Yield is expressed in bushels/acre.

TABLE 2

| | | | | Moles | | | |
|---|---|---|---|---|---|---|---|
| | Active | Rate | Lbs. | (AI)/ | Yield | Yield | % Diff |
| Product | Ingredient (AI) | (oz/acre) | (AI)/Acre | Acre | treated | control | Yield |
| VALOR ® | flumioxazin | 0.50 | 0.0159375 | 0.02041 | 94.1 | 64.8 | 45.2 |
| SX | (51% w/w) | | | | | | |
| VERDICT ® | 0.57 lb./gal | 0.75 | 0.00334 and 0.0293 | 0.0029and 0.0481 | 90.2 | 73.2 | 23.2 |
| 0.75 | saflufenacil, 5 | | | | | | |
| | lb./gal | | | | | | |
| | dimethenamid | | | | | | |
| VALOR ® | flumioxazin | 0.50 | 0.0159375 | 0.0204 | 80.1 | 70.8 | 23 |
| SX | (51% w/w) | | | | | | |
| COBRA ® | lactofen 2 lb./gal | 6.00 | 0.09375 | 0.0921 | 82.4 | 71.9 | 14.6 |
| 6 | | | | | | | |
| SURTAIN ® | 0.626 lb./gal | 1.00 | 0.00489 and 0078 | 0.0044 and 0.0090 | 83 | 74.1 | 12 |
| 1.0 | saflufenacil, | | | | | | |
| | 1.00 lb./gal | | | | | | |
| | pyroxasulfone | | | | | | |
| VALOR ® | flumioxazin | 0.50 | 0.0159375 | 0.0204 | 81.8 | 73.9 | 10.7 |
| 0.5 (Hot)* | (51% w/w) | | | | | | |
| SURTAIN ® | 0.626 lb./gal | 2.00 | 0.00978 | 0.0088 and 0.0189 | 81.9 | 74.1 | 10.5 |
| 2.0 | saflufenacil, | | | | | | |
| | 1.00 lb./gal | | | | | | |
| | pyroxasulfone | | | | | | |
| SHARPEN ® | 2.85 lb./gal | 0.75 | 0.016699219 | 0.0151 | 86.4 | 80.4 | 7.5 |
| .075 | saflufenacil | | | | | | |
| COBRA ® | lactofen 2 lb./gal | 12.00 | 0.1875 | 0.1841 | 69.9 | 64.4 | 8.5 |
| 12 (Hot)* | | | | | | | |
| COBRA ® | lactofen 2 lb./gal | 12.00 | 0.1875 | 0.1841 | 69.7 | 64.4 | 8.2 |
| 12 | | | | | | | |
| SHARPEN ® | 2.85 lb./gal | 0.15 | 0.003339844 | 0.0030 | 84.5 | 79.5 | 6.3 |
| 0.15 | saflufenacil | | | | | | |
| COBRA ® | lactofen 2 lb./gal | 6.00 | 0.09375 | 0.0920 | 57.2 | 52.8 | 8.3 |
| 6 | | | | | | | |
| COBRA ® | lactofen 2 lb./gal | 6.00 | 0.09375 | 0.0920 | 72.7 | 70.2 | 3.6 |
| 6 | | | | | | | |
| COBRA ® | lactofen 2 lb./gal | 6.00 | 0.09375 | 0.0920 | 77.7 | 75.5 | 2.9 |
| 6 (Hot) | | | | | | | |
| STATUS ® | 16% | 0.10 | 0.001 and 0.0025 | 00133 and 0.0051 | 85.7 | 83.7 | 2.4 |
| 0.10 | diflufenapyr, | | | | | | |
| | 40% dicamba | | | | | | |
| SPARTAN ® | 4 lb./gal | 2.00 | 0.0625 | 0.0732 | 90.8 | 89.0 | 2 |
| 2.0 | sulfentrazone | | | | | | |
| COBRA ® | lactofen 2 lb./gal | 6.00 | 0.09375 | 0.0921 | 79.2 | 77.5 | 2.2 |
| 6 | | | | | | | |
| CROSSBOW ® | 2 lb./gal 2, 4 D | 0.25 | 0.0039 and 0.00195 | 0.0081 and 0.0034 | 62.2 | 61.1 | 1.8 |
| | plus 1 lb./gal | | | | | | |
| | triclopyr | | | | | | |

*Hot denotes addition of 200 oz MSO and 100 oz UAN 32%;
Volume of water (solvent) used is 75.6 liters;
% Diff. Yield = (bushels/acre treated) − (bushels/acre control)/(bushels/acre control)*100

For the data presented above it is evident that the application of herbicides, especially certain herbicides applied at specific concentrations result in injury, damage, or inhibition of the growth of the meristem which subsequently results in overcompensation and an increase yield expressed in bushels per acre of soybean plants.

Several chemical agents, such as methyl esters of C₈ and C₁₀ fatty acids as well as methylated seed oil (MSO) are known inducers of overcompensation in plants. Formulations of these chemical agents were used as positive controls in this trial. Based on the data, these chemical agents increased the number of soybean bushels per acre.

FIG. 1 shows a bar graph expressing an increased yield (bu/acre) for two herbicides, VALOR® and VERDICT® applied at 0.5 oz/acre and 0.75 oz/acre. Two formulations of VALOR®were used. VALOR® (hot) refers to a formulation comprising VALOR® and MSO. FIG. 1 shows that treatment with herbicide is effective with increased yields of soybeans produced compared to control untreated plants.

### Example 2: General Protocol for Green House Experiments

Soybean (Glycine max L.) seed were planted 1.25 cm deep in 20-cm diameter pots filled with a sterilized field soil, vermiculite and peat mix placed in 2.5 cm h trays. Five seeds were equally spaced in two lines with a common central seed then thinned to 3 plants at the VC stage. The experimental unit was three seedlings per pot with three replicates. Herbicides were applied when plants reached V2 to V5 growth stage using a single-nozzle research track spray chamber (DeVries Manufacturing, Hollandale, MN, USA) equipped with AI9502EVS nozzle (TeeJet Technologies, Spraying Systems Co., Wheaton, IL, USA). A carrier volume of 140 L ha⁻¹ was used in all applications. Plants were maintained in the glasshouse at 20 to 35° C. (night/day), with a natural ventilation system. Natural lighting was supplemented with artificial lighting from 400 W high-pressure sodium light bulbs simulating a 16 h photoperiod. Plants were bottom watered as needed and fertigated bi-weekly weekly with 10 g of 46-0-0 (urea) per tray.

Recorded observations at 7 and 14 days included apical meristem injury, foliar injury rating and release of axillary buds. Plants were harvested at approximately V8 and R1 stage and the V-stage, height, number of short branches (<2 nodes), large branches (>=3 branches), nodes, blooms, and pods were all measured.

### Example 3

Several intermediate-scale soybean plots were delineated for use in an experiment that measured the increase in yield expressed as bushels/acre based on seed varieties and the application of a formulation comprising chemical herbicides. These experiments were done in central Illinois.

Three plots were used in this study. The area of field plots used in this study were approximately 0.65-0.70 acres. Soybean seeds were planted in each of the three plots on May 29, 2025. Chemical treatment was applied to a single plot (hereafter referred to as the treated plot) and two plots were used as reference control plots. Reference control plots were within 1000 ft of the treated plot (within the same 40-ac field block). All agronomic practices were identical across the experimental field site.

Flumioxazin herbicide (VALOR®) was applied to the single plot at a broadcast rate of 0.45 oz/ac with 10 oz/ac MSO and 10 oz/ac of ACTIVATOR® 90 using a 10-row, low boom with ultra-low spray drift spray tips, in accordance with the Valor specimen label. Flumioxazin was applied to the treated plot on Jul. 2, 2025, when the soybean plants are at a vegetative growth stage between V3 and V5. All plots were harvested using a conventional harvester on the same day, Sep. 26, 2025, when the measured moisture content of soybeans was approximately 11%. Yield data from the treated plot and the two untreated plots were derived from weighting cart data and seed moisture. Treatment with herbicide resulted in a 6% increase in yield compared to the average yields of the two reference control plots (namely, 72.0 bu/ac).

TABLE 3

| | Yield (moisture |
|---|---|
| Plot | corrected), bu/ac |
| Flumioxazin (0.45 oz/ac) | 76.1 |
| Reference control 1 | 74.0 |
| Reference control 2 | 69.9 |

What is claimed is:

1. A method of improving one or more agronomic traits of a plant comprising:
(a) applying a composition comprising one or more active ingredients that are herbicides to a shoot apical meristem of the plant in an amount effective to kill, damage, or inhibit the growth of cells in the shoot apical meristem and
(b) improving one or more agronomic traits of the plant compared to an untreated control plant.

2. The method of claim 1, wherein the one or more active ingredients that are herbicides is selected from the group consisting of an acetyl CoA carboxylase inhibitor, acetolactate synthase inhibitor, 5-enolpyruvyl-shikimate-3-phosphate synthase inhibitor, auxin transport inhibitor, photosystem II inhibitor, glutamine synthase inhibitor, diterpene synthesis inhibitor, 4-hydroxyphenyl-pyruvate dioxygenase inhibitor, proto-porphyrinogen oxidase inhibitor, photosystem I electron diverter, microtubule inhibitor, non-acetyl CoA carboxylase lipid synthesis inhibitor, a long-chain fatty acid synthesis inhibitor and combinations thereof.

3. The method of claim 1, wherein the one or more active ingredients that are herbicides is selected from the group consisting of fenoxaprop, fluazfop, quizalofop, clethodim, sethoxydim, chlorimuron, foramsulfuron, halosulfuron, iodosulfuron, nicosulfuron, primisulfuron, prosulfuron, timsulfuron, thifensulfuron, tribenuro, imazamox, imazaquin, imazapyr, imazethapyr, flumetsulam, cloransulam, thiencarbazone, thiencarbazone, glyphosate, 2,4-D, dicamba, clopyalid, fluroxypyr, difufenzopyr, atrazine, simazine, metribuzin, bromoxynil, bentazon, linuron, glufosinate, clomazone, isoxaflutole, topramezone, mesotrione, tembotrione, acifluorfen, fomesafen, lactofen, flumiclorac, sulfentrazone, carfentrazone, fluthiacet-ethyl, saflufenacil, paraquat, ethalfluralin, pendimethalin, trifluralin, butylate, EPTC, acetochlor, alachlor, metolachlor, dimethenamid, flufenacet, pyroxasulfone, and combinations thereof.

4. The method of claim 1, wherein the one or more active ingredients that are herbicides does not comprise lactofen.

5. The method of claim 1, wherein the composition comprising one or more active ingredients that are herbicides is applied to the shoot apical meristem of the plant at a rate from about 0.1 ounces/acre to about 20 ounces/acre.

6. The method of claim 1, wherein the concentration of the active ingredients that are herbicides in the composition is in a range from about 0.01 mM to about 5.0 mM.

7. The method of claim 1, wherein the composition further comprises one or more surfactants.

8. The method of claim 7, wherein the one or more surfactants are selected from the group consisting of polyoxyethylene sorbitan esters, polyoxyethylene alcohols, alkylarylpolyether alcohols, phthalic glycerol alkyl resins, ethoxylated imidazoline, decanoic acid, diglycol oleate, polyether sulfonates, alkylaryl sulfonates, and combinations thereof.

9. The method of claim 7, wherein the one or more surfactants is selected from the group consisting of polyoxyethylene (20) sorbitan monolaurate, polyoxyethylene (4) sorbitan monolaurate, polyoxyethylene (2) sorbitan monopalmiate, polyoxyethylene (20) sorbitan monostearate, polyoxyethylene (20) sorbitan monooleate, ethoxylated imidazoline, polyoxyethylene fatty glyceride, polyoxyethylene fatty glyceride, polyoxyethylene (12) dodecylophenol and combinations thereof.

10. The method of claim 7, wherein the total weight of the one or more surfactants in the composition is approximately equal to the total weight of the one or more active ingredients that are herbicides in the composition.

11. The method of claim 1, wherein the composition further comprises one or more fungicides, bactericides, and/or pesticides.

12. The method of claim 1, wherein the one or more agronomic traits is selected from the group consisting of seed yield, tuber yield, fruit yield, pod yield, seed oil content, seed protein content, seed starch content, biomass, flower number, drought tolerance, pest tolerance, pathogen tolerance and a combination thereof.

13. The method of claim 1, further comprising harvesting one or more commercially relevant portions of the plant.

14. The method of claim 13, wherein the commercially relevant portion of the plant is selected from the group consisting of seeds, tubers, fruit, pods, oil, protein, starch, leaves, fiber, terpenes, wood, and a combination thereof.

15. The method of claim 1, wherein the plant is selected from the group consisting of soybean, corn, canola, rice, cotton, potato, sunflower, camelina, and rape.

16. A method of improving one or more agronomic traits of a plant comprising:
(a) applying a composition comprising one or more Proto-Porphyrinogen Oxidase (PPO) inhibitors to the shoot apical meristem of the plant in an amount effective to kill, damage, or inhibit the growth of cells in the shoot apical meristem; and
(b) improving one or more agronomic traits of the plant compared to an untreated control plant.

17. The method of claim 16, wherein the PPO inhibitors are selected from the group consisting of flumioxazin, saflufenacil, and sulfentrazone.

18. The method of claim 16, wherein the composition further comprises one or more surfactants.

19. The method of claim 18, wherein the one or more surfactants is selected from the group consisting of polyoxyethylene (20) sorbitan monolaurate, polyoxyethylene (4) sorbitan monolaurate, polyoxyethylene (2) sorbitan monopalmiate, polyoxyethylene (20) sorbitan monostearate, polyoxyethylene (20) sorbitan monooleate, ethoxylated imidazoline, polyoxyethylene fatty glyceride, polyoxyethylene fatty glyceride, polyoxyethylene (12) dodecylophenol and combinations thereof.

20. The method of claim 17, wherein the concentration of the active ingredients that are herbicides in the composition is in a range from about 0.01 mM to about 5.0 mM.
